(19) United States
(12) Patent Application Publication
(10) Pub. No.: US 2008/0169257 A1
(43) Pub. Date: Jul. 17, 2008

(54) Hoisting crane with annular bearing structure

(75) Inventors: Joop Roodenburg, Delft (NL); Gerrit Van Wijk, Ridderkerk (NL); Adriaan Jan Rodenburg, Rotterdam (NL)

Correspondence Address: BIRCH STEWART KOLASCH & BIRCH, PO BOX 747, FALLS CHURCH, VA, 22040-0747, US

(73) Assignee: Itrec B.V., Schiedam (NL)

(21) Appl. No.: 11/653,958

(22) Filed: Jan. 17, 2007

(51) Int. Cl. B66C 23/84

(52) U.S. Cl. 212/253; 384/107

(57) ABSTRACT

This invention relates to a hoisting crane comprising a jib, a jib connection member which is disposed on the column and to which the jib is connected pivotably. The crane further comprises an annular bearing structure extending around the column guiding and carrying the jib connection member rotatable about the column. The annular bearing structure comprises one or more column bearing parts comprising column bearing surfaces associated with the vertical column and one or more jib bearing parts comprising jib bearing surfaces associated with the jib connection member, whereby the column bearing surfaces and the jib bearing surfaces are arranged opposite from each other. A first column bearing surface is oriented substantially vertically and is arranged in a radial direction more inwards than the opposed first jib bearing surface, to support radially inwards directed horizontal loads from the jib connection member to the column. A second column bearing surface is oriented substantially horizontally and is arranged below the opposed second jib bearing surface, to support downwardly directed vertical loads from the jib connection member to the column. According to a first aspect of the invention, a third column bearing surface is oriented substantially vertically and is arranged in a radial direction more outwards than the opposed third jib bearing surface. According to a second aspect of the invention the first substantially vertical jib bearing surface has circumferentially uniformly been pre-stressed in a radially inward direction.

The invention relates to a hoisting crane in accordance with the preamble of claim 1. Hoisting cranes of this type have already been commercially available from the applicant for decades, in particular for installation on a vessel, such as for example a cargo vessel, a tender vessel used in the offshore industry, etc.

WO2005123566 describes a hoisting crane according to the preamble of claim 1. An annular bearing structure extends around the vertical column and guides and carries a jib connection member, so that the jib connection member, and therefore the jib, can rotate about the column. As an example, it is disclosed that the annular bearing structure comprises one or more guide tracks which extend around the column and on which an annular bearing component of the jib connection member is supported via running wheels. Two jib securing supports are arranged on the jib connection member. Drive motors for rotating the jib connection member each have a pinion, which engages with a toothed track.

Vertical load components arise from the jib connection member itself, from the jib, and from loads applied to the jib. When loading the jib, not only vertical forces arise but also radially inward directed forces at the part of the annular bearing where the jib is provided. Radially outward directed forces arise at the opposite part of the annular bearing opposite the jib. When heavier loads are to be handled by the crane, a more robust crane construction is required to compensate for these forces. In particular the bearing structure needs to be stronger and more robust and stiff, and hence heavier.

It is an object of the invention to propose an improved hoisting crane of the type in accordance with the preamble of claim 1. The proposed improvements allow a lighter construction of the crane.

According to a first embodiment of the invention, the hoisting crane is characterized in that the annular bearing structure further comprises substantially vertically extending bearing surfaces whereby a column bearing surface associated with the vertical column is arranged in a radial direction more outwards than a jib bearing surface associated with the jib connection member. These additional bearing surfaces compensate for the radially outward directed forces and prevent possible displacement which can result from these forces. The column bearing part associated with the column prevents the jib bearing part associated with the jib connection member from moving in an outward radial direction, in particular bearing parts situated radially opposite the jib. The bearing part associated with the column thus fixates the bearing part associated with the jib connection member. As a result of this bearing construction absorbing outwardly directed forces, the required crane construction can be less robust and hence lighter.

Alternatively the invention provides a second embodiment according to claim 14. In this embodiment radially outward directed forces are absorbed/compensated by pre-stressing of the jib bearing surfaces associated with the jib.

A possible method of pre-stressing of the bearing surface associated with the jib connection member is by heating the bearing surface provided on a bearing part associated with the jib connection member to cause expansion of the bearing part associated with the jib. A metal bearing part may be heated e.g. up to 60° C. or more. Subsequently the vertical bearing surface associated with the jib connection member is assembled around the vertical bearing surface associated with the column and cooled down. Cooling down causes shrinkage of the bearing part, causing circumferentially uniform stresses in a radially inward direction. These stresses prevent radially outward directed displacement of one or more of the bearing parts associated with the jib connection member.

Further advantageous embodiments are described in the dependent claims and in the following description with reference to the drawing.

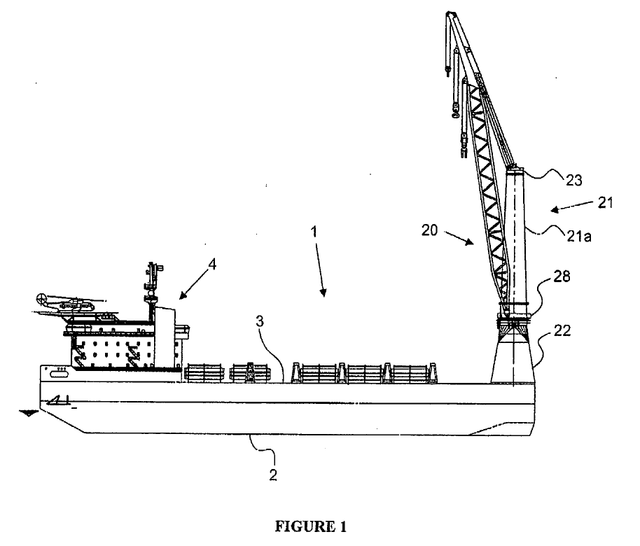

FIG. 1 diagrammatically depicts a vessel comprising a hoisting crane;

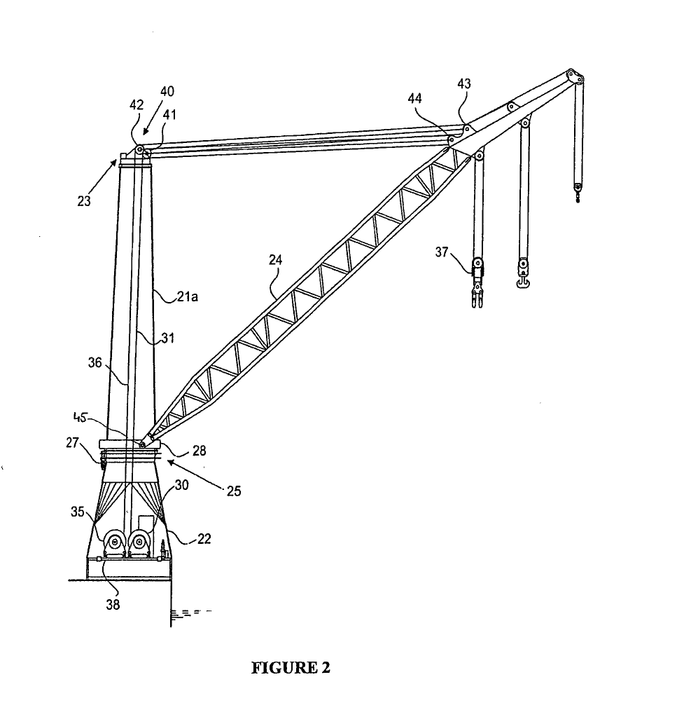

FIG. 2 shows a hoisting crane at the rear side of a vessel, partially in the form of a cut-away view;

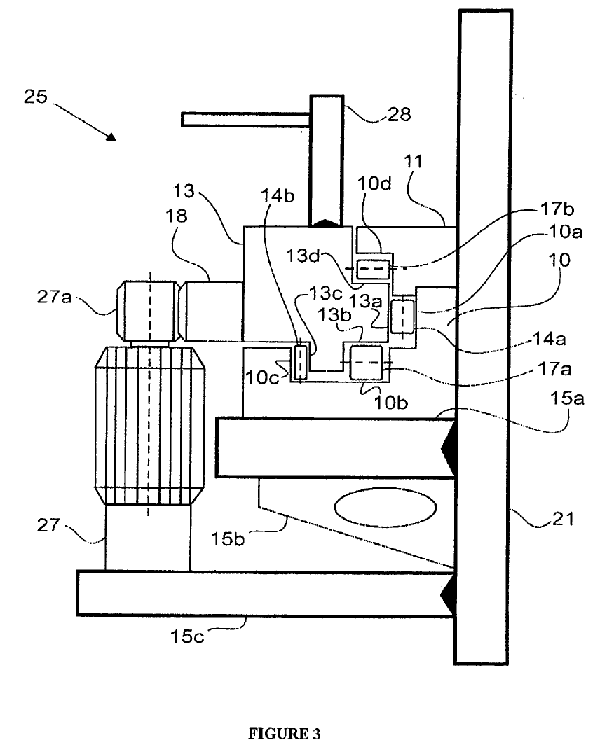

FIG. 3 shows a preferred embodiment of an annular bearing according to the first aspect of the invention;

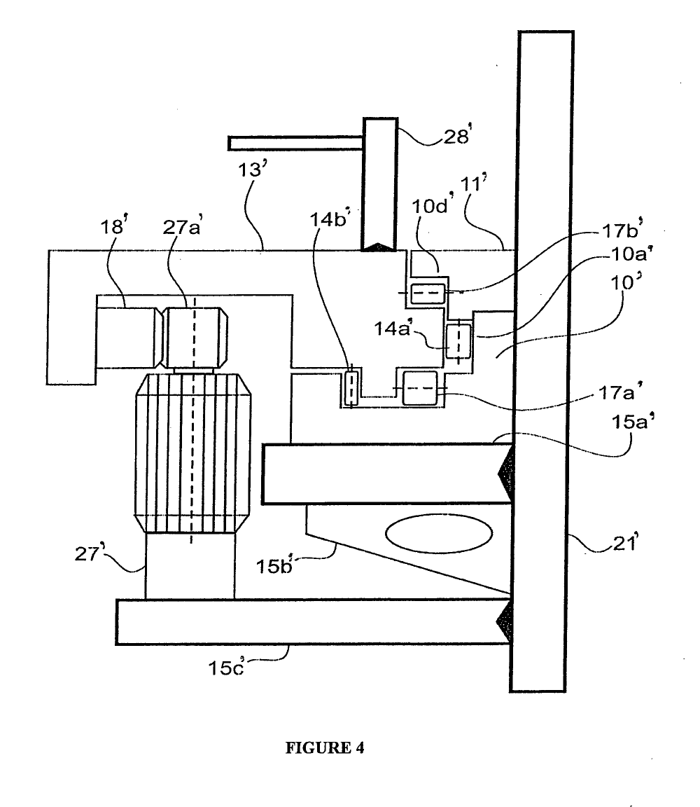

FIG. 4 shows an alternative embodiment of an annular bearing according to the first aspect of the invention;

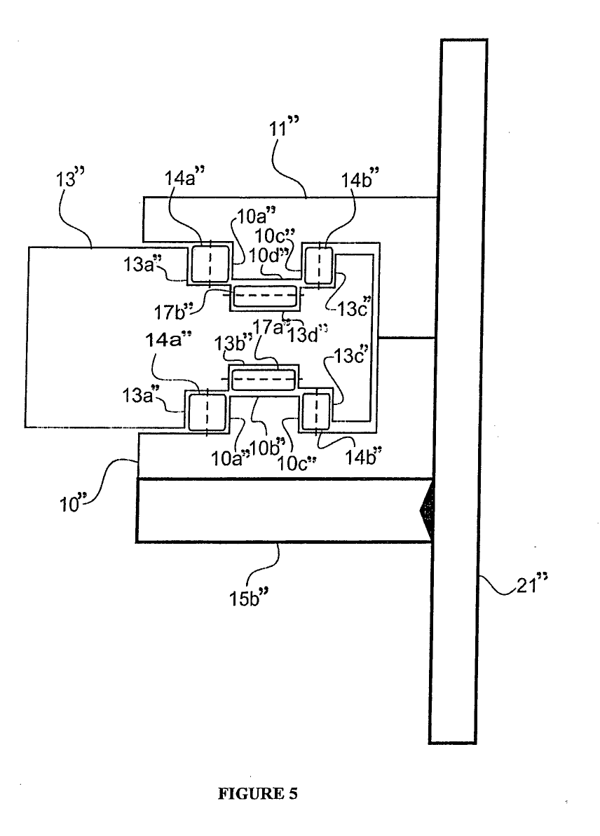

FIG. 5 shows another alternative embodiment of an annular bearing according to the first aspect of the invention;

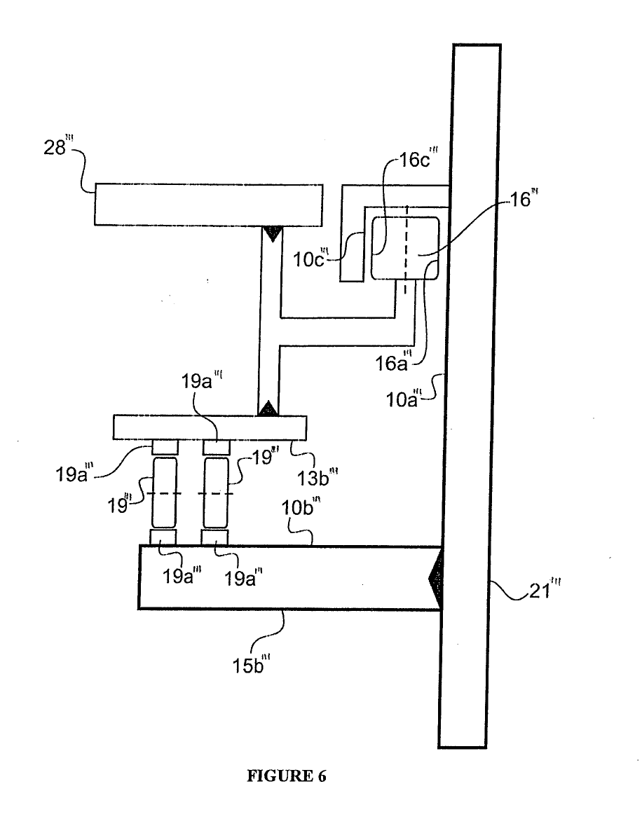

FIG. 6 shows yet another alternative embodiment of an annular bearing according to the first aspect of the invention;

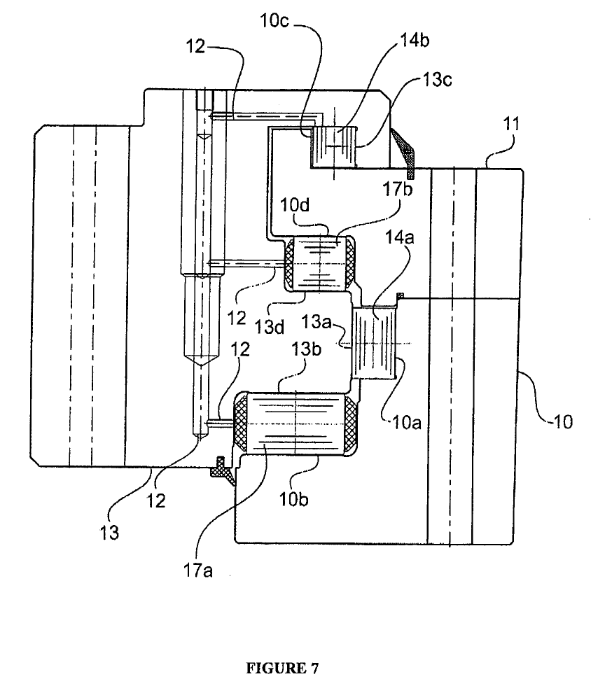

FIG. 7 shows yet another alternative embodiment of an annular bearing according to the first aspect of the invention;

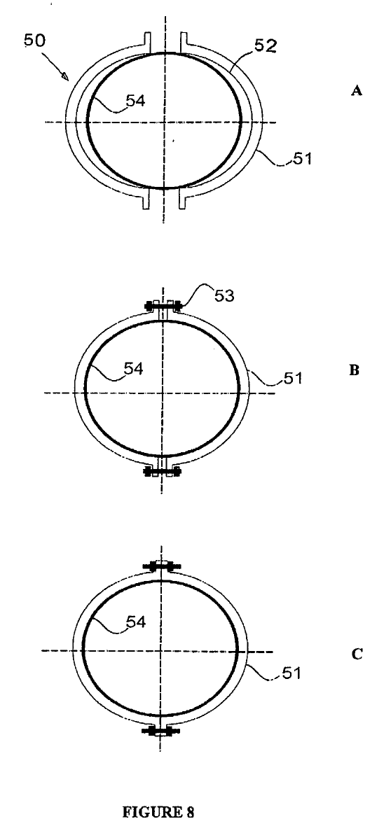

FIGS. 8a-8c shows an embodiment of an annular bearing according to the second aspect of the invention.

FIG. 1 is a side view of a vessel 1 comprising a hoisting crane 20 comprising a bearing structure 25 according to the invention. The vessel 1 has a hull 2 with a working deck 3 and, at the front of the hull 2, a superstructure 4 for crew accommodation, etc. The vessel 1 has a hoisting crane 20, disposed at the rear side of the vessel 1, which hoisting crane 20 has a vertical structure fixed to the hull 2. The hoisting crane 20 will be described in more detail below.

The hoisting crane 20, which is illustrated in detail in FIG. 2, has a substantially hollow vertical column 21 with a foot 22, which in this case is fixed to the hull 2 of the vessel 1. Alternatively, the foot 22 of the crane 20 can be fixed to any other support, e.g. a quay on the mainland. Furthermore, the column 21 has a top 23. Between the foot and the top the column 21 has a body 21a. Furthermore the hoisting crane 20 comprises a jib 24.

An annular bearing structure 25 extends around the vertical column 21 and guides and carries a jib connection member 28, so that the jib connection member 28, and therefore the jib 24, can rotate about the column 21. The annular bearing structure will be discussed in more detail below. In this case, the jib 24 is connected pivotably to the jib connection member 28 via a substantially horizontal pivot axis 45, so that the jib 24 can also be pivoted up and down. There is at least one drive motor 27 for displacing the jib connection member 28 along the annular bearing structure 25.

To pivot the jib 24 up and down, there is a topping winch 30 provided with a topping cable 31 which engages on the jib 24.

Furthermore, the hoisting crane 20 comprises a hoisting winch 35 for raising and lowering a load, with an associated hoisting cable 36 and a hoisting hook 37. At the top 23 of the column 21 there is a top cable guide 40 provided with a cable pulley assembly 41 for the topping cable 31 and with a second cable pulley assembly 42 for the hoisting cable 36.

One or more third cable pulley assemblies 43 for the hoisting cable 36 and a fourth cable pulley assembly 44 for the topping cable 31 are arranged on the jib 24. The number of cable parts for each cable can be selected as appropriate by the person skilled in the art.

The winches 30 and 35 are in this case disposed in the foot 22 of the vertical column 21, so that the topping cable 31 and the hoisting cable 36 extend from the associated winch 30, 35 upward, through the hollow vertical column 21 to the top cable guide 40 and then towards the cable guides 43, 44 on the jib 24.

The top cable guide 40 has a rotary bearing structure, for example with one or more running tracks around the top of the column 21 and running wheels, engaging on the running tracks, of a structural part on which the cable pulley assemblies are mounted. As a result, the top cable guide can follow rotary movements of the jib about the vertical column 21 and adopt substantially the same angular position as the jib 24.

The top cable guide 40 may have an associated drive motor assembly which ensures that the top cable guide 40 follows the rotary movements of the jib 24 about the column 21, but an embodiment without drive motor assembly is preferred.

The winches 31 and 35 are in this embodiment arranged on a movable winch support 38, which is mounted movably with respect to the vertical column 21. The winch support 38 here is located in the vertical crane structure, preferably in the region of the foot 22 under the circular cross section part of the column 21, and is mechanically decoupled from the top cable guide 40. The support 38 could e.g. also be arranged in the hull of the vessel below the column, e.g. the foot could have an extension which extends into the hull.

In FIG. 3 a preferred embodiment of an annular bearing structure 25 is shown. The annular bearing structure 25 is provided between the vertical column 21 and the jib connection member 28 and comprises in this embodiment two bearing parts 10, 11 comprising bearing surfaces associated with the vertical column 21 and a bearing part 13 comprising bearing surfaces associated with the jib connection member 28. Load bearing supports 15a, 15c are connected to vertical column 21 by welding. Support 15a is further supported by beam 15b. Bearing parts 10, 11 are connected to each other and to load bearing support 15a, for example by a bolt (not shown). Bearing part 13 is connected to the jib connection member 28 by welding.

The shown annular bearing structure comprises vertically extending bearing surfaces 10a, 13a, whereby first column bearing surface 10a provided on bearing part 10 associated with the vertical column 21 is arranged in a radial direction more inwards than first jib bearing surface 13a provided on bearing part 13 associated with the jib connection member 28. This construction supports radially inwards directed horizontal loads from the jib connection member to the column.

The shown annular bearing structure further comprises horizontally extending bearing surfaces 13b, 10b, whereby second column bearing surface 10b provided on bearing part 10 associated with the vertical column 21 is arranged below second jib bearing surface 13b provided on bearing part 13 associated with the jib connection member 28. This construction supports downwardly directed vertical loads from the jib connection member 28 to the column 21. These loads e.g. occur as a result of hoisting by the crane.

The annular bearing structure further comprises vertically extending bearing surfaces 10c, 13c, whereby third column bearing surface 10c provided on bearing part 10 associated with the vertical column 21 is arranged in a radial direction more outwards than third jib bearing surface 13c provided on bearing part 13 associated with the jib connection member 28. This construction prevents radially outward directed displacement of bearing part 13 associated with the jib connection member 28, which possibly occur at the side of the bearing opposite the jib

The annular bearing structure further comprises horizontally extending bearing surfaces 10d, 13d, whereby fourth column bearing surface 10d provided on bearing part 11 associated with the vertical column 21 is arranged above fourth jib bearing surface 13d provided on bearing part 13 associated with the jib connection member 28, to support upwardly directed vertical loads from the jib connection member to the column 21, which possibly occur as a result of the use of the crane.

Between vertical bearing surfaces 13a, 10a and 10c, 13c first and second vertical rollers 14a, 14b are provided with a vertical axis. Between horizontal bearing surfaces 10b, 13b, 10d, 13d, first and second horizontal rollers 17a, 17b are provided with a horizontal axis to facilitate the mutual movement of the bearing surfaces. Alternatively, ball bearings, a lubricant, water or any other type of intermediate between the bearing surfaces may be applied.

A gear ring 18 with is provided around bearing part 13 associated with the jib connection member 28. Gear ring 18 has teeth projecting radially. At least one drive motor 27 being connected with the column 21 may drive a pinion 27a which engages with the gear ring 18, driving the jib connection member 28 around column 21. In a preferred embodiment, three or four drive motors are provided at one side of the column 21, usually opposite a common position of the jib 28.

An alternative drive arrangement is presented in FIG. 4. The drive motor 27 is still connected with the column 21 and drives pinion 27a, which engages with the gear ring 18′, driving the jib connection member 28 around column 21. In the arrangement of FIG. 4, however, the gear ring 18′ is provided inside bearing part 13. This is particularly advantageous since in case of deformation whereby the bearing part 13 associated with the jib connection member 28 moves in an outward radial direction a clearance between gear ring 18′ and pinion 27a arises. This is less damaging to the motor than the embodiment shown in FIG. 3. In case of deformation whereby the bearing part 13 associated with the jib connection member 28 moves in an outward radial direction in this embodiment gear ring 18 will damage pinion 27a and possibly also motor 27.

FIG. 5 depicts schematically an alternative bearing structure according to the invention. Same parts have been given same numbers and similar components have been kept away.

FIG. 6 depicts schematically yet another alternative bearing structure according to the invention. Same parts have been given same numbers and similar components have been kept away. Instead of horizontal rollers between horizontal bearing surfaces 10b and 13b flanged rollers 19 encircling the column 21 on rails 19a are provided. Between vertical bearing surfaces 10a and 10c associated with (and in the shown embodiment directly connected to) the column 21 are provided load rollers 16, preferably arranged in a linked sequence forming a chain of radial load rollers. This bearing structure is an improvement to a bearing structure for a crane as shown in WO 2004/076902. Rollers 16 are capable of rotating the jib when driven with a motor. Rollers 16 define first load roller bearing surfaces 16a associated with the jib connection member. Load roller bearing surfaces 16a, positioned in a radial outward direction of the first column bearing surface 10a, support radially inwards directed horizontal loads. Second load roller bearing surfaces 16c defined by roller 16 are positioned in a radial inward direction of the third column bearing surface 10c and absorb radially outward directed forces.

FIG. 7 depicts schematically yet another alternative bearing structure according to the invention. Same parts have been given same numbers and similar components have been kept away.

Lubricant channel 12 are included in this bearing structure, through which a lubricant can be added between the bearing surfaces and the rollers.

FIGS. 8a-8c show an annular bearing 50 according to the second aspect of the invention. Two bearing parts 51 comprising substantially vertical jib bearing surfaces 52 associated with the jib connection member are arranged around column bearing surface 54 associated with the column. The bearing parts 51 are connected to each other by bolts 53. The bearing parts 51 are stressed in a radially inward direction to prevent radially outward directed displacement of one or more of the bearing parts 51 associated with the jib connection member, in particular bearing parts situated radially opposite the jib. The stresses are preferably induced by heating the bearing parts 51 to at least 60° C. and subsequently cooling them down, e.g. by rinsing them with ice water. Alternatively, the stresses are induced by tightening the bolts.

1-16. (canceled)

17. A hoisting crane, comprising:
a substantially hollow vertical column comprising a foot and a top and a body between the foot and the top;
a jib;
a jib connection member disposed on the column, the jib being pivotably connected to the jib connection member; and
an annular bearing structure extending around the column, the annular bearing structure guiding and carrying the jib connection member rotatably about the column, the annular bearing structure comprising:
one or more column bearing parts connected to the column comprising column bearing surfaces associated with the vertical column; and
one or more jib bearing parts connected to the jib connection member comprising jib bearing surfaces associated with the jib connection member,
wherein a first column bearing surface is oriented substantially vertically and is arranged in a radial direction more inwards than a first jib bearing surface, to support radially inwards directed horizontal loads from the jib connection member to the column, the first jib bearing surface being arranged opposite to the first column bearing surface,
wherein a second column bearing surface is oriented substantially horizontally and is arranged below a second jib bearing surface, to support downwardly directed vertical loads from the jib connection member to the column, the second jib bearing surface being arranged opposite to the second column bearing surface, and
wherein a third column bearing surface is oriented substantially vertically and is arranged in a radial direction more outwards than a third jib bearing surface, the third jib bearing surface being arranged opposite to the third column bearing surface.

18. The hoisting crane according to claim 17, wherein a fourth column bearing surface is oriented substantially horizontally and is arranged above a fourth jib bearing surface, to support upwardly directed vertical loads from the jib connection member to the column, the fourth jib bearing surface being arranged opposite to the fourth column bearing surface.

19. The hoisting crane according to claim 17, wherein the third column bearing surface is only provided in a part of the annular bearing, opposite from the jib.

20. The hoisting crane according to claim 17, wherein the third column bearing surface is only provided in a part of the annular bearing, where the jib is situated.

21. The hoisting crane according to claim 17, wherein the first jib bearing surfaces and the first column bearing surfaces are arranged parallel to each other, and the second jib bearing surfaces and the second column bearing surfaces are arranged parallel to each other, and the third jib bearing surfaces and the third column bearing surfaces are arranged parallel to each other.

22. The hoisting crane according to claim 17, wherein the annular bearing structure comprises one ore more rollers with a vertical axis arranged between the vertically extending first and third jib bearing surfaces and the vertically extending first and third column bearing surfaces.

23. The hoisting crane according to claim 17, wherein the annular bearing structure comprises one ore more rollers with a horizontal axis arranged between the horizontally extending second jib bearing surfaces and the horizontally extending column bearing surfaces.

24. The hoisting crane according to claim 17, wherein the annular bearing structure comprises one ore more hydrostatic bearings between the jib bearing surfaces and column bearing surfaces.

25. The hoisting crane according to claim 17, wherein the annular bearing structure includes load rollers defining a bearing surface associated with the jib connection member.

26. The hoisting crane according to claim 17, wherein the annular bearing structure comprises one jib bearing component comprising all horizontal and vertical jib bearing surfaces associated with the jib connection member.

27. The hoisting crane according to claim 17, wherein the crane includes at least one motor for driving the jib connection member.

28. The hoisting crane according to claim 27, wherein the at least one motor is connected to the column next to part of the annular bearing, at a location opposite from the jib.
